(19) United States
(12) Patent Application Publication
(10) Pub. No.: US 2024/0295868 A1
(43) Pub. Date: Sep. 5, 2024

(54) NUMERICAL CONTROL DEVICE

(71) Applicant: FANUC CORPORATION, Minamitsuru-gun, Yamanashi (JP)

(72) Inventors: Zhaojia LIU, Oshino-mura, Minamitsuru-gun (JP); Takumi OOHASHI, Oshino-mura, Minamitsuru-gun (JP)

(21) Appl. No.: 18/573,149

(22) PCT Filed: Jul. 27, 2021
(86) PCT No.: PCT/JP2021/027719

§ 371 Date: Dec. 21, 2023

(51) Int. Cl. G05B 19/4093; G05B 19/4097

(52) U.S. Cl. CPC G05B 19/40932; G05B 19/4097; G05B 2219/35216

(57) ABSTRACT

The numerical control device includes a G-code registration unit for registering associated information in which a uniquely customized custom G-code, one or more items set in the custom G-code, the type of the shape set for each of the items, and the type of extracted data extracted from the shape are associated, an associated information storage unit for storing the registered associated information, and a selected shape reception unit for receiving a shape selected by a user. The device also includes a data type acquisition unit for acquiring the type of the extracted data and the item corresponding to the selected shape, a setting data calculation unit for calculating setting data based on the selected shape, the acquired item, and the type of the extracted data, and an item data setting unit for setting, to the acquired item, the setting data calculated by the setting data calculation unit.

### TECHNICAL FIELD

The present invention relates to a numerical control device.

### BACKGROUND ART

For instance, as illustrated in FIG. 32, a technique is known in which, a machine tool builder prepares a custom macro program and unique custom G-codes (such as “G100”) for use in calling the macro program, and the users can easily call the macro program by the unique custom G-codes customized by the machine tool builder. See Patent Document 1, for example.

Another technique is known in which, when one block of NC data is created, a display screen displays an image showing the functions of G-codes as well as what data should be inputted when executing the functions of the G-codes, and NC data is created by referring to this image. See Patent Document 2, for example.

### CITATION LIST

### Patent Document

Patent Document 1: Japanese Patent No. 6654740
Patent Document 2: Japanese Unexamined Patent Application, Publication No. S62-052608

### DISCLOSURE OF THE INVENTION

### Problems to be Solved by the Invention

However, Patent Documents 1 and 2 require directly inputting numerical values for each shape-related item of the standard G-code or unique custom G-code, which requires time and effort to create a program.

Therefore, it has been desired to enable each shape-related item of a custom G-code to be inputted quickly and easily.

### Means for Solving the Problems

An aspect of a numerical control device according to the present disclosure includes: a G-code registration unit configured to register association information that associates a uniquely customized custom G-code, at least one item set in the custom G-code, a type of shape set for each item, and a type of extracted data extracted from the shape; an association information storage unit configured to store the association information registered; a selected shape receiving unit configured to receive a shape selected by a user from among shapes indicated by CAD data displayed on a CAD data display unit; a data type acquisition unit configured to query the association information storage unit by using the shape selected, and acquire an item and a type of extracted data corresponding to the shape selected; a setting data calculation unit configured to calculate setting data, based on the item and the type of extracted data acquired, and the shape selected; and an item data setting unit configured to set the setting data calculated by the setting data calculation unit to the item acquired.

### Effects of the Invention

According to one aspect of the present invention, each shape-related item of a custom G-code can be inputted quickly and easily.

### BRIEF DESCRIPTION OF THE DRAWINGS

FIG. 1 is a functional block diagram illustrating a functional configuration example of a numerical control device according to one embodiment;

FIG. 2 is a diagram illustrating an example of a data structure of association information registered by a G-code registration unit;

FIG. 3 is a diagram illustrating an example of CAD data of a gear;

FIG. 4 is a diagram illustrating an example of the association information in the case of a custom G-code that calls a program for machining a gear;

FIG. 5 is a diagram illustrating an example of CAD data of a workpiece, in which a plurality of holes are generated on the circumference;

FIG. 6 is a diagram illustrating an example of the association information in the case of a custom G-code that calls a program for machining a plurality of holes at equal intervals on the circumference;

FIG. 7 is a diagram illustrating an example of the association information of a custom G-code “G100”;

FIG. 8 is a diagram illustrating an example of the association information of the custom G-code “G100”;

FIG. 9 is a diagram illustrating an example of a registration screen in the case of registering a custom G-code “G200”;

FIG. 10 is a diagram illustrating an example of a registration screen in the case of registering the custom G-code “G200”;

FIG. 11 is a diagram illustrating an example of the registration screen in the case of registering the custom G-code “G200”;

FIG. 12 is a diagram illustrating an example of the registration screen in the case of registering the custom G-code “G200”;

FIG. 13 is a diagram illustrating an example of the registration screen in the case of registering the custom G-code “G200”;

FIG. 14 is a diagram illustrating an example of the registration screen in the case of registering the custom G-code “G200”;

FIG. 15 is a diagram illustrating an example of a setting screen in the case of the custom G-code “G100”;

FIG. 16 is a diagram illustrating an example of the setting screen in the case of the custom G-code “G100”;

FIG. 17 is a diagram illustrating an example of the setting screen in the case of the custom G-code “G200”;

FIG. 18 is a diagram illustrating an example of the setting screen in the case of the custom G-code “G200”;

FIG. 19 is a diagram illustrating an example of setting the setting items;

FIG. 20 is a diagram illustrating an example of setting the setting items;

FIG. 21 is a diagram illustrating an example of setting the setting items;

FIG. 22 is a diagram illustrating an example of setting the setting items;

FIG. 23 is a diagram illustrating an example of setting the setting items;

FIG. 24 is a diagram illustrating an example of setting the setting items;

FIG. 25 is a flowchart illustrating registration processing of the numerical control device;

FIG. 26 is a flowchart illustrating program generation processing of the numerical control device;

FIG. 27 is a diagram illustrating an example of a setting screen in the case where the priority order is “currently selected item”;

FIG. 28 is a diagram illustrating an example of setting the setting items in the case where the priority order is “manually select a setting item”;

FIG. 29 is a diagram illustrating an example of setting the setting items in the case where the priority order is “manually select a setting item”;

FIG. 30 is a diagram illustrating an example of setting the setting items in the case where the priority order is “manually select a setting item”;

FIG. 31 is a diagram illustrating an example of setting the setting items in the case where the priority order is “manually select a setting item”; and

FIG. 32 is a diagram illustrating an example of an operation of a custom G-code that calls a macro program.

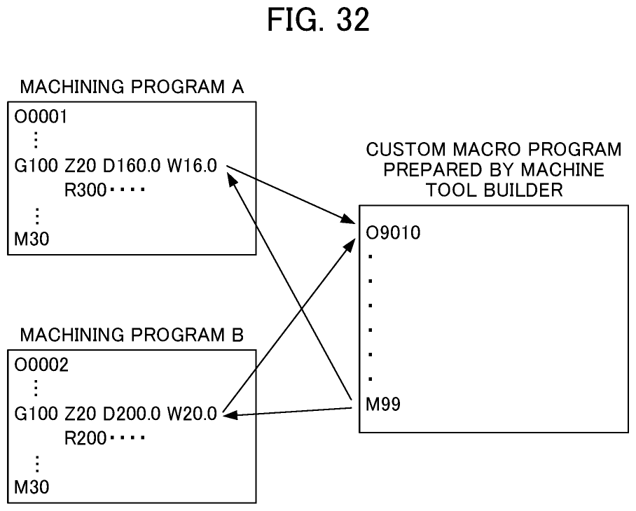

### PREFERRED MODE FOR CARRYING OUT THE INVENTION

### One Embodiment

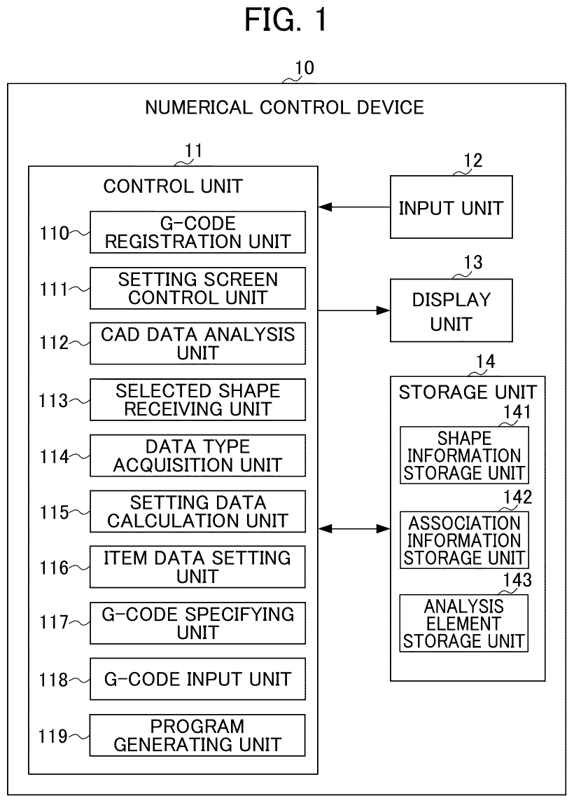

FIG. 1 is a functional block diagram illustrating a functional configuration example of a numerical control device according to one embodiment.

A numerical control device 10 is a numerical control device known to those skilled in the art, generates operation commands based on control information, and outputs the generated operation commands to a machine tool (not illustrated). In this manner, the numerical control device 10 controls the operation of the machine tool (not illustrated). Note when the machine tool (not illustrated) is a robot or the like, the numerical control device 10 may be a robot control device or the like.

The numerical control device 10 may be directly connected to the machine tool (not illustrated) via an interface (not illustrated). The numerical control device 10 and the machine tool (not illustrated) may be connected to each other through a network (not illustrated) such as a LAN (Local Area Network) or the Internet. In this case, the numerical control device 10 includes a communication unit (not illustrated) for mutual communication via such a connection.

Here, the machine tool (not illustrated) is, for example, a machine tool, a robot, or peripheral devices, etc. The machine tool (not illustrated) is not limited to machine tools, robots, peripheral devices, etc., but can be widely applied to industrial machines in general. Industrial machines include various machines such as machine tools, industrial robots, service robots, forging machines, and injection molding machines.

As illustrated in FIG. 1, the numerical control device 10 includes a control unit 11, an input unit 12, a display unit 13, and a storage unit 14. The control unit 11, the input unit 12, the display unit 13, and the storage unit 14 are communicably connected via a bus (not illustrated). The control unit 11 includes a G-code registration unit 110, a setting screen control unit 111 as a setting order display unit, a CAD data analysis unit 112, a selected shape receiving unit 113, a data type acquisition unit 114, a setting data calculation unit 115, an item data setting unit 116, a G-code specifying unit 117, a G-code input unit 118, and a program generating unit 119.

### <Input Unit 12>

The input unit 12, for example, is a keyboard, or a touch panel arranged on the display unit 13 described later, and receives inputs from the user, such as an input of a specified G-code used for a machining program of the machine tool (not illustrated).

### <Display Unit 13>

The display unit 13, for example, is a liquid crystal display, and displays a registration screen for registering a custom G-code, based on the control commands of the G-code registration unit 110 described later. The display unit 13 as a CAD data display unit displays CAD data of a workpiece generated using a custom G-code, and displays a setting screen for automatically selecting and setting the setting items of the custom G-code, based on the control commands of the setting screen control unit 111 described later. The registration screen and the setting screen will be described later.

### <Storage Unit 14>

The storage unit 34, such as a ROM (Read Only Memory) or an HDD (Hard Disk Drive), includes a shape information storage unit 141, an association information storage unit 142, and an analysis element storage unit 143.

The shape information storage unit 141 stores CAD data and the like indicating the shape of a workpiece to be generated by a machining operation of the machine tool (not illustrated).

In order to set numerical values of a plurality of parameters of a custom G-code used for generating a machining program (hereinafter also referred to as “setting items”) by using CAD data of a workpiece to be generated by the machining program, the association information storage unit 142 stores association information for each custom G-code, in which the custom G-code, a plurality of setting items, the type of shape selected from the CAD data for each setting item (hereinafter also referred to as “selected shape”), the type of data of the selected shape extracted from the CAD data (hereinafter also referred to as “type of extracted data”), and another setting item set from the same selected shape, have been associated in advance.

Here, another setting item set from the same selected shape will be described. For example, as will be described later, when the same circle is selected for a plurality of setting items, as the shape selected for each setting item from the CAD data, it is more efficient to collectively set a plurality of types of extracted data, such as the central coordinates in the X-axis direction, the central coordinates in the Y-axis direction, and the radius from the selected shapes of the circle, among the setting items (parameters) of the custom G-code. Therefore, a plurality of setting items set from the same selected shape can be collectively set by setting “another setting item set from the same selected shape” in the association information.

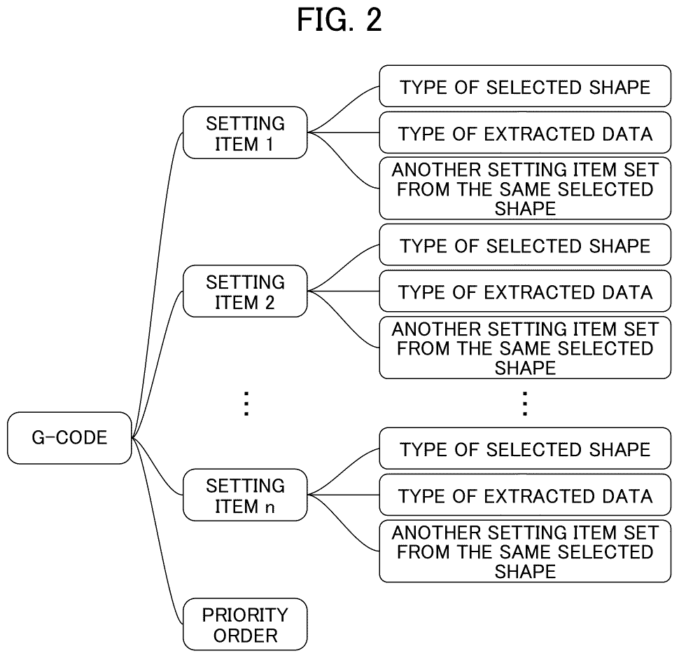

FIG. 2 is a diagram illustrating an example of the data structure of the association information.

As illustrated in FIG. 2, the association information has a data structure with three layers. The first layer stores the custom G-code registered by the G-code registration unit 110 described later. The second layer stores n setting items 1 to n that are set for the custom G-code registered in the first layer (n is an integer of 1 or more). The third layer stores, for each setting item in the second layer, the type of selected shape, the type of extracted data, and another setting item set from the same selected shape.

As illustrated in FIG. 2, the association information may store, in the second layer, priority order information that indicates the order for setting the setting items. The setting order will be described later.

Hereinafter, more specifically, (a) association information in the case of a custom G-code that calls a program for machining a gear, and (b) association information in the case of a custom G-code that calls a program for machining a plurality of holes on the circumference, will be described.

(a) Association Information in the Case of a Custom G-Code that Calls a Program for Machining a Gear

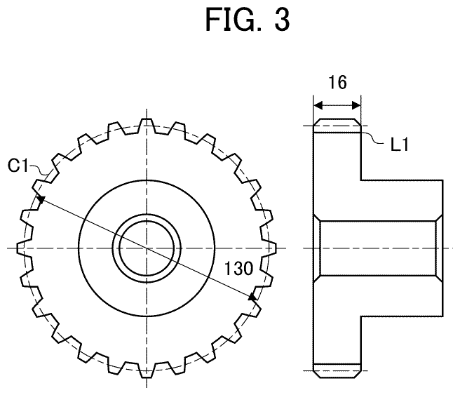

FIG. 3 is a diagram illustrating an example of CAD data of a gear. The left side of FIG. 3, for example, illustrates the CAD data of the gear in the XY plane as viewed from the Z-axis direction, where the diameter of a circle C1 of the gear (hereinafter also referred to as “workpiece outer diameter”) is set to, for example, 130 mm. The right side of FIG. 3, for example, illustrates the CAD data of the gear in the ZX plane (or ZY plane) as viewed from the Y-axis (or X-axis) direction, where the width of a straight line L1 of the gear (hereinafter also referred to as “workpiece tooth width”) is set to, for example, 16 mm.

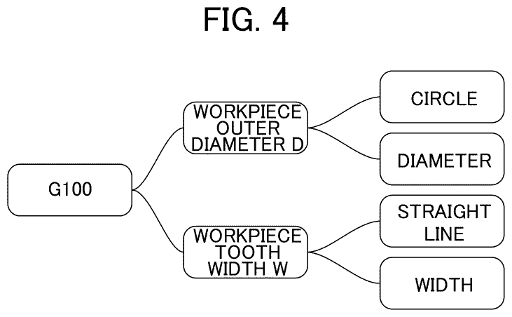

FIG. 4 is a diagram illustrating an example of the association information in the case of the custom G-code that calls a program for machining the gear illustrated in FIG. 3.

As illustrated in FIG. 4, for example, the custom G-code “G100” that calls the program for machining the gear is stored in the first layer of the association information. The “workpiece outer diameter D” indicating the diameter of the circle C1 of the gear, and the “workpiece tooth width W” indicating the width of the straight line L1 of the gear are stored as the setting items in the second layer of the association information. “D” and “W” represent address names (variable names of the custom G-code).

For the setting item “workpiece outer diameter D”, the type of selected shape selected “circle” of the circle C1 from the CAD data, and the type of extracted data “diameter” of the circle C1 extracted from the CAD data are stored in the third layer of the association information. The “straight line” of the straight line L1 as the type of selected shape selected from the CAD data, and the “width” of the straight line L1 as the type of extracted data extracted from the CAD data are stored for the setting item “workpiece tooth width W”.

Note that, as illustrated in FIG. 3, the selected shape “circle” for the setting item “workpiece outer diameter D” and the selected shape “straight line” for the setting item “workpiece tooth width W” have different shapes; therefore, another setting item set from the same selected shape is not set in the third layer of the association information illustrated in FIG. 4.

(b) Association Information in the Case of a Custom G-Code that Calls a Program for Machining a Plurality of Holes on the Circumference

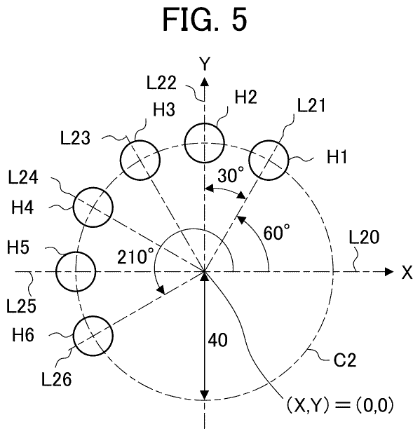

FIG. 5 is a diagram illustrating an example of CAD data for a workpiece in which a plurality of holes are created at equal intervals on the circumference. FIG. 5 illustrates, for example, CAD data for a workpiece in which six holes H1 to H6 are generated at equal intervals on the circumference of a circle C2 with a radius of 40 mm on the XY plane viewed from the Z-axis direction.

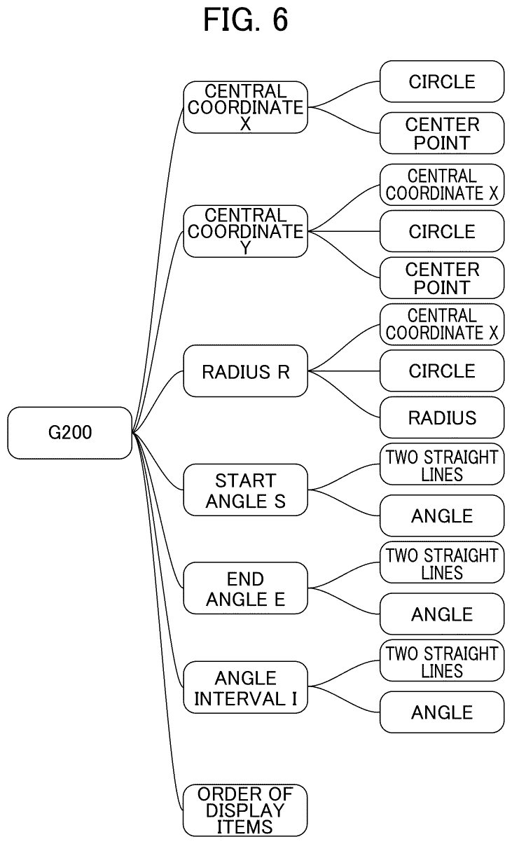

FIG. 6 is a diagram illustrating an example of the association information in the case of a custom G-code that calls a program for machining a plurality of holes at equal intervals on the circumference of the circle in FIG. 5.

As illustrated in FIG. 6, for example, the first layer of the association information stores the custom G-code “G200” that calls a program for machining a plurality of holes at equal intervals on the circumference. The second layer of the association information stores, as the setting items, the “central coordinate X” representing the central coordinate in the X-axis direction of the circle C2, the “central coordinate Y” representing the central coordinate in the Y-axis direction of the circle C2, and the “radius R” representing the radius of the circle C2.

By denoting a straight line in the X-axis direction as L20, the second layer of the association information stores, as the setting items, the “start angle S” representing the angle (such as 60°) Formed by the straight line L20 and the straight line L21 connecting the center point and the first hole H1, the “end angle E” representing the angle (such as 210°) formed by the straight line L20 and the straight line L26 connecting the center point and the last hole H6, and the “angle interval I” representing the angle (such as 30°) between the straight line L21 and the straight line L22 connecting holes H1 and H2.

The third layer of the association information stores the “circle” as the type of selected shape selected from the CAD data, and the “center point” as the type of extracted data extracted from the CAD data, for the setting item “central coordinate X”. The same “circle” as the type of selected shape selected from the CAD data, and the “center point” as the type of extracted data extracted from the CAD data are stored for the setting item “central coordinate Y”; and the “central coordinate X” is also stored as another setting item set from the same selected shape. The same “circle” as the type of selected shape selected from the CAD data, and the “radius” as the type of extracted data extracted from the CAD data are stored for the setting item “radius R”; and the “central coordinate X” is also stored as another setting item set from the same selected shape.

As a result, as will be described later, in the case of selecting the circle C2 of the CAD data in FIG. 5, the numerical control device 10 can collectively set the setting items “central coordinate X”, “central coordinate Y”, and “radius R”.

The third layer of the association information stores the “two straight lines” as the type of selected shape selected from the CAD data, and the “angle” as the type of extracted data extracted from the CAD data, for the setting item “start angle S”. For the setting item “end angle E”, the “two straight lines” as the type of selected shape selected from the CAD data, and the “angle” as the type of extracted data extracted from the CAD data are stored. The “two straight lines” as the type of selected shape selected from the CAD data, and the “angle” as the type of extracted data extracted from the CAD data are stored, for the setting item “angle interval I”.

The type of selected shape and the type of extracted data for the setting items “start angle S”, “end angle E”, and “angle interval I” are the same as the type of selected shape “two straight lines” and the type of extracted data “angle”; therefore, the user needs to be able to distinguish them when setting, as described later. Therefore, as will be described later, the second layer of the association information in FIG. 6 sets the priority order indicating the setting order for setting the setting items “start angle S”, “end angle E”, and “angle interval I” (for example, the item display order for displaying the setting items).

The CAD data analysis unit 112 (described later) analyzes the CAD data stored in the shape information storage unit 141, whereby the analysis element storage unit 143 stores the constituent elements of the shapes composing the CAD data.

### <Control Unit 11>

The control unit 11 includes CPU (Central Processing Unit), ROM, RAM (Random Access Storage), CMOS (Complementary Metal-Oxide-Semiconductor) memory, etc., which are communicably connected with each other through a bus, and are known to those skilled in the art.

The CPU is a processor that totally controls the numerical control device 10. The CPU reads a system program and application programs stored in the ROM via the bus, and controls the entire numerical control device 10 in accordance with the system program and the application programs. As illustrated in FIG. 1, this configuration allows the control unit 11 to implement the functions of the G-code registration unit 110, the setting screen control unit 111, the CAD data analysis unit 112, the selected shape receiving unit 113, the data type acquisition unit 114, the setting data calculation unit 115, the item data setting unit 116, G-code specifying unit 117, the G-code input unit 118, and the program generating unit 119. The RAM stores various types of data such as temporary calculation data and display data. The CMOS memory is backed up by a battery (not illustrated), and is configured as a non-volatile memory that retains its memory state even when the power supply of the numerical control device 10 is turned off.

### <G-Code Registration Unit 110>

The G-code registration unit 110 registers the association information, which associates a custom G-code uniquely customized by a machine tool builder, etc. for generating machining programs, at least one setting item set in the custom G-code, the type of shape set for each setting item, and the type of extracted data extracted from the shape.

Hereinafter, the specific registration operation of the G-code registration unit 110 will be described by examples of (a) the case of a custom G-code that calls a program for machining the gear illustrated in FIG. 3, and (b) the case of a custom G-code that calls a program for machining the plurality of holes at equal intervals on the circumference illustrated in FIG. 5.

(a) The Case of a Custom G-Code that Calls a Program for Machining the Gear Illustrated in FIG. 3

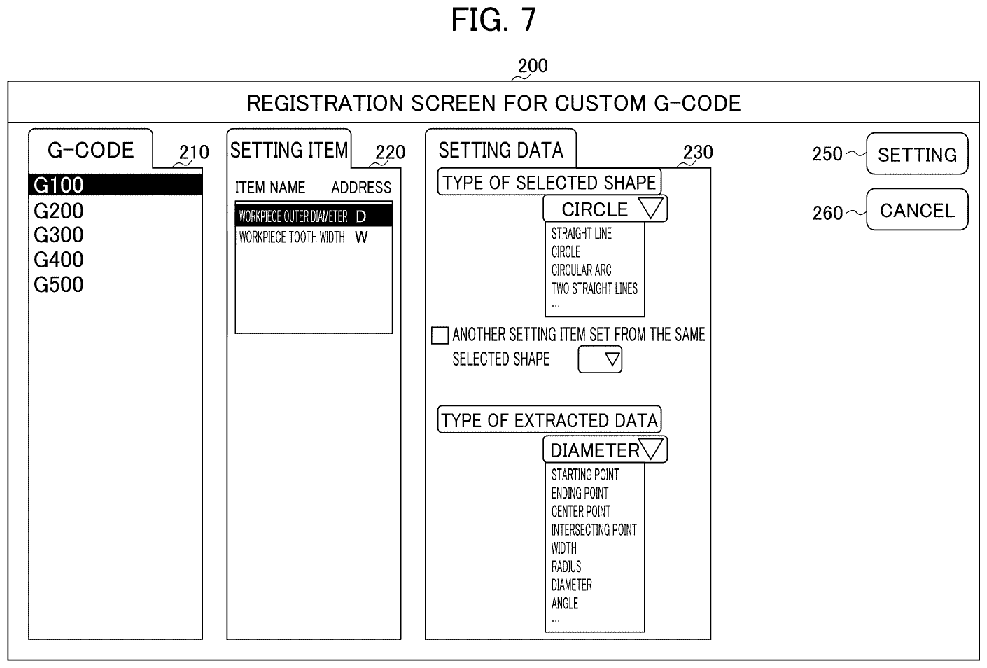

FIG. 7 is a diagram illustrating an example of a registration screen for registering the custom G-code “G100”.

In the case of receiving a registration command for a custom G-code, based on an input operation of the input unit 12 by the user, the G-code registration unit 110 displays the registration screen 200 on the display unit 13, as illustrated in FIG. 7.

As illustrated in FIG. 7, the registration screen 200 includes a G-code 210, a setting item 220, a setting data 230, a setting button 250, and a cancel button 260.

In the G-code 210 corresponding to the first layer of the association information in FIG. 4, the G-code registration unit 110 receives an input of the custom G-code “G100” that calls a program for machining a gear, based on an input operation of the input unit 12 by the user.

In the setting item 220 corresponding to the second layer of the association information in FIG. 4, the G-code registration unit 110 receives, for example, inputs of the item name of the setting item set in the custom G-code “G100” inputted in the G-code 210, and the address name corresponding to the item name (variable names of the custom G-code), based on an input operation of the input unit 12 by the user. For example, in the case of the custom G-code “G100” that calls a program for machining a gear, the item name “workpiece outer diameter” and the address name “D”, as well as the item name “workpiece tooth width” and the address name “W”, are inputted in the setting item 220 by the user.

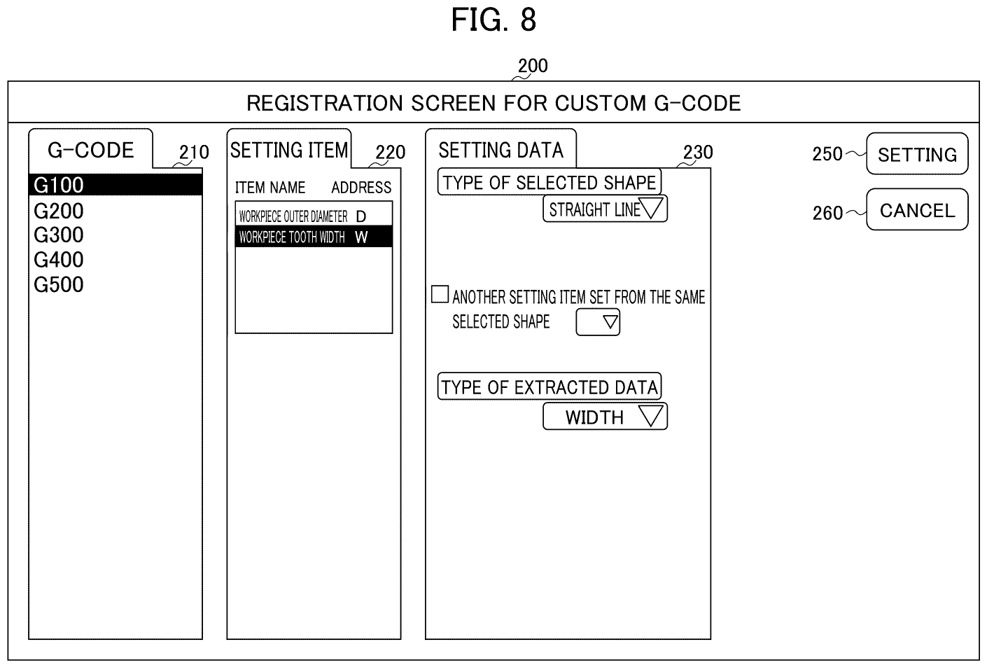

In the setting data 230 corresponding to the third layer of the association information in FIG. 4, the G-code registration unit 110 receives, for example, the type of selected shape and the type of extracted data for each setting item in the setting item 220, based on an input operation of the input unit 12 by the user. Specifically, in the setting data 230, for example, the type of selected shape “circle”, and the type of extracted data “diameter” are set by the user, for the setting item “workpiece outer diameter D” of the setting item 220. In the setting data 230, as illustrated in FIG. 8, the type of selected shape “straight line”, and the type of extracted data “width” are set by the user, for the setting item “workpiece tooth width W” of the setting item 220.

After setting the items in the G-code 210, the setting item 220, and the setting data 230, when the setting button 250 is pressed based on an input operation of the input unit 12 by the user, the G-code registration unit 110 registers the association information of the custom G-code “G100” in FIG. 4, and stores it in the association information storage unit 142.

On the other hand, after setting the items in the G-code 210, the setting item 220, and the setting data 230, when the cancel button 260 is pressed based on an input operation of the input unit 12 by the user, the G-code registration unit 110 cancels the registration of the association information of the custom G-code “G100” in FIG. 4.

(b) The Case of a Custom G-Code that Calls a Program for Machining the Plurality of Holes at Equal Intervals on the Circumference of FIG. 5

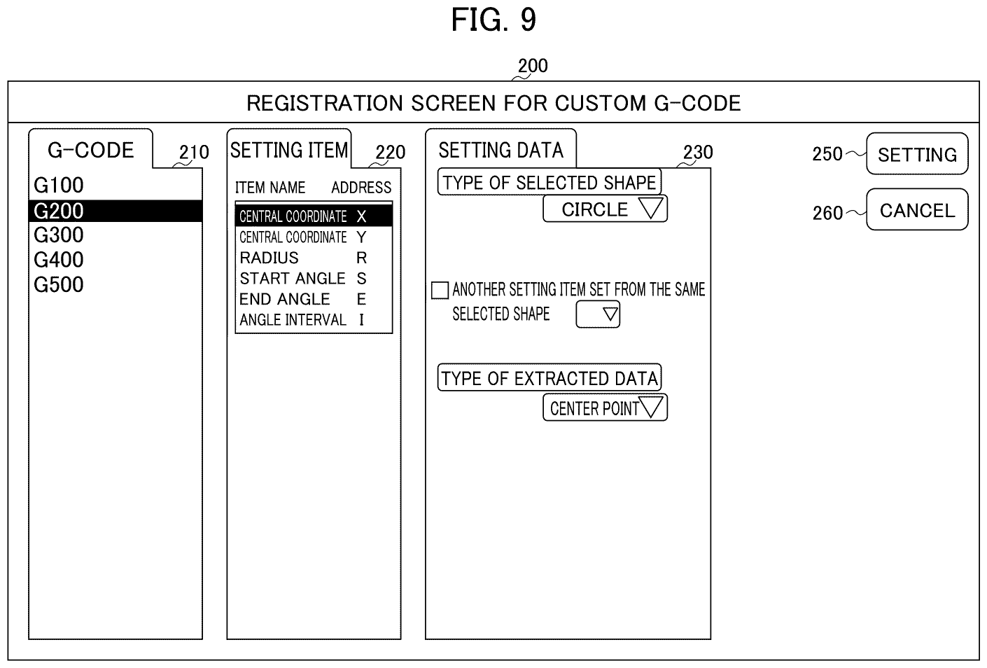

FIG. 9 is a diagram illustrating an example of a registration screen when registering the custom G-code “G200”.

For example, when a registration command for the custom G-code is received based on an input operation of the input unit 12 by the user, the G-code registration unit 110 displays the registration screen 200 illustrated in FIG. 9 on the display unit 13, in the same manner as FIG. 7.

The G-code registration unit 110 receives the input of the custom G-code “G200” in the G-code 210 corresponding to the first layer of the association information in FIG. 6, based on an input operation of the input unit 12 by the user, as mentioned above.

The G-code registration unit 110 receives, for example, inputs of the item name “central coordinate” and the address name “X”, the item name “central coordinate” and the address name “Y”, the item name “radius” and the address name “R”, the item name “starting angle” and the address name “S”, the item name “ending angle” and the address name “E”, as well as the item name “angle interval” and the address name “I”, in the setting item 220 corresponding to the second layer of the association information in FIG. 6, based on an input operation of the input unit 12 by the user, as mentioned above.

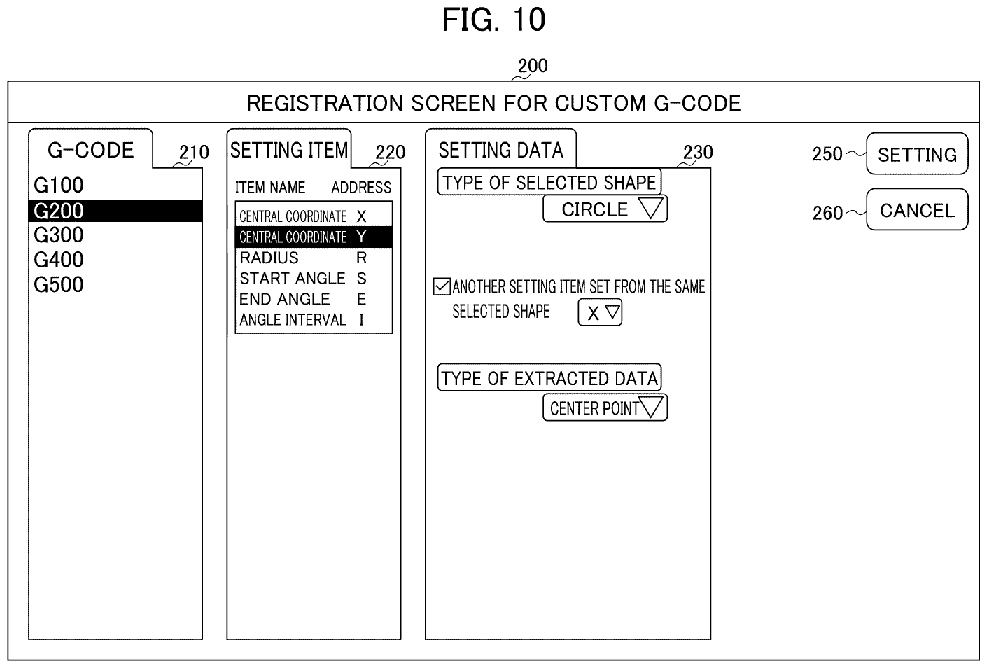

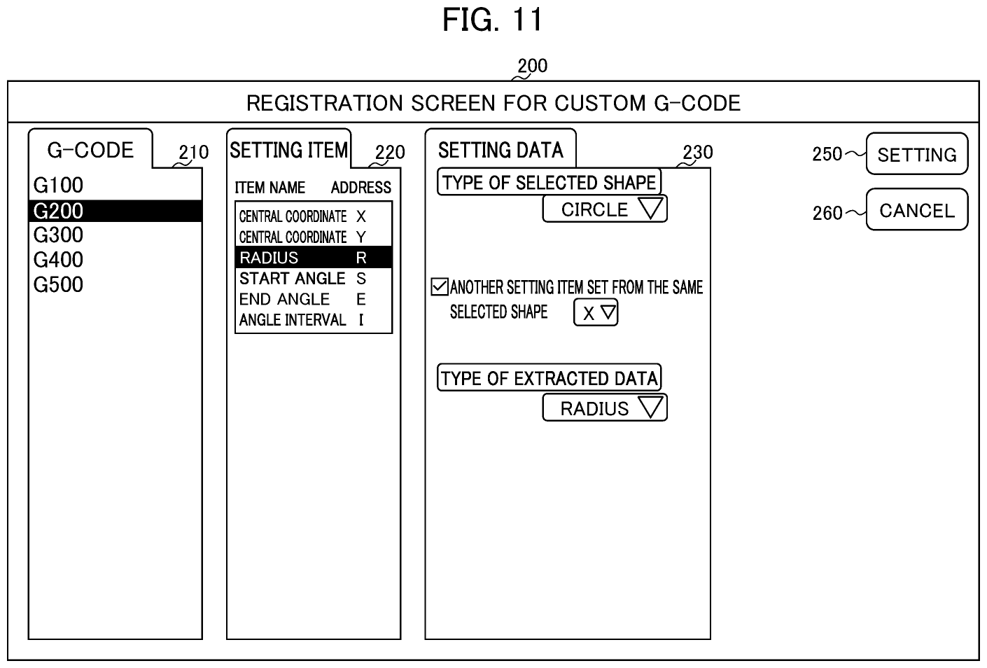

The G-code registration unit 110, for example, sets the type of selected shape “circle” and the type of extracted data “center point”, for the setting item “central coordinate X” of the setting item 220, based on an input operation of the input unit 12 by the user, in the setting data 230 corresponding to the third layer of the association information in FIG. 6, as mentioned above. In the setting data 230, as illustrated in FIG. 10, the type of selected shape “circle” and the type of extracted data “center point” are set by the user for the setting item “central coordinate Y” of the setting item 220; and the “central coordinate X” as another setting item set from the same selected shape is also set by the user. In the setting data 230, as illustrated in FIG. 11, the type of selected shape “circle” and the type of extracted data “radius” are set by the user for the setting item “radius R” of the setting item 220; and the “central coordinate X” as another setting item set from the same selected shape is also set by the user.

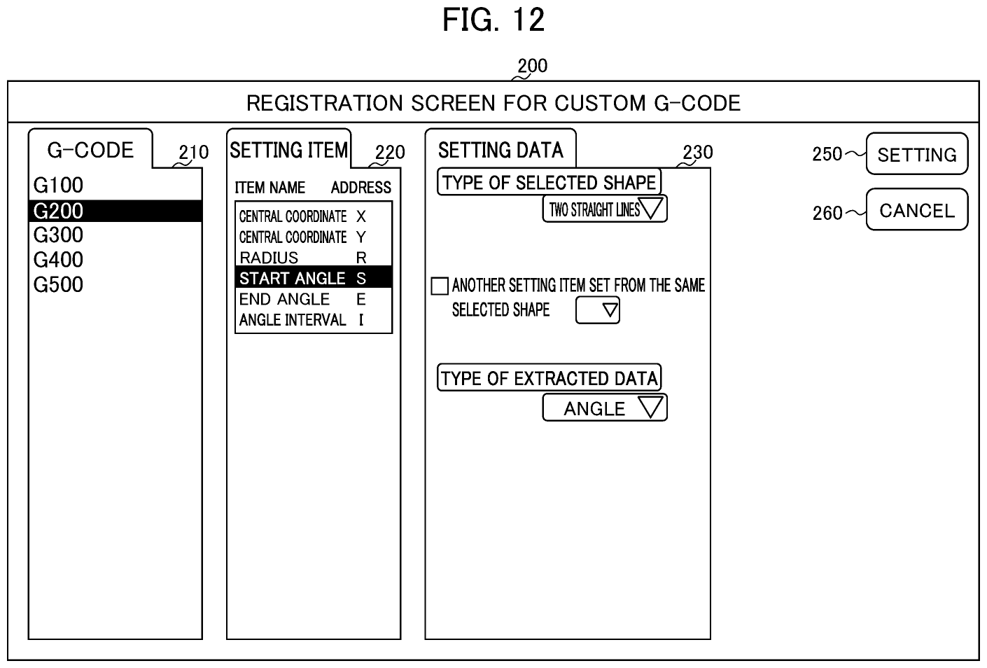

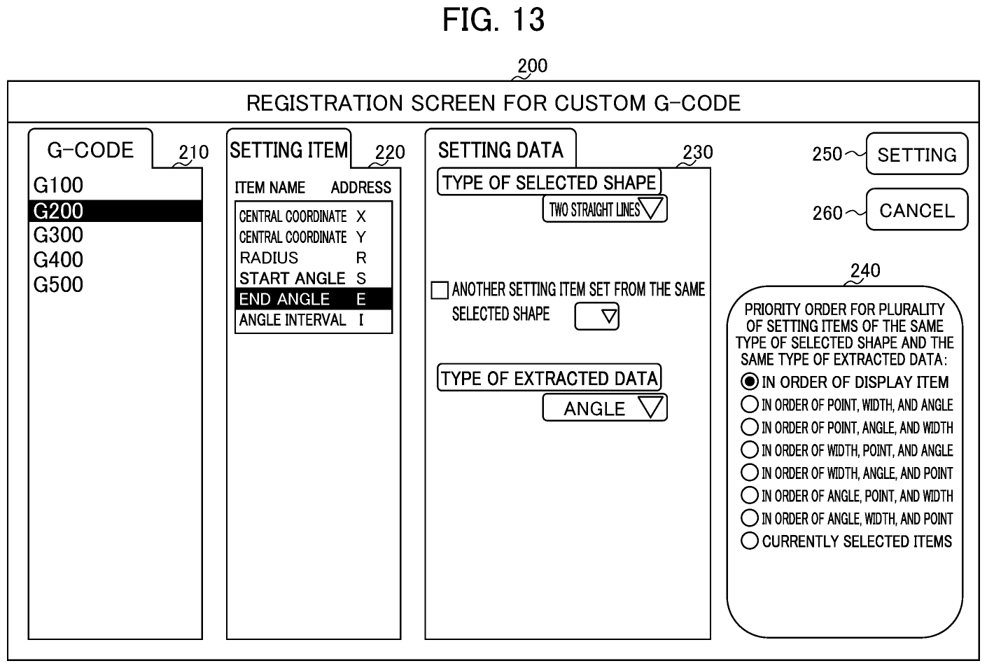

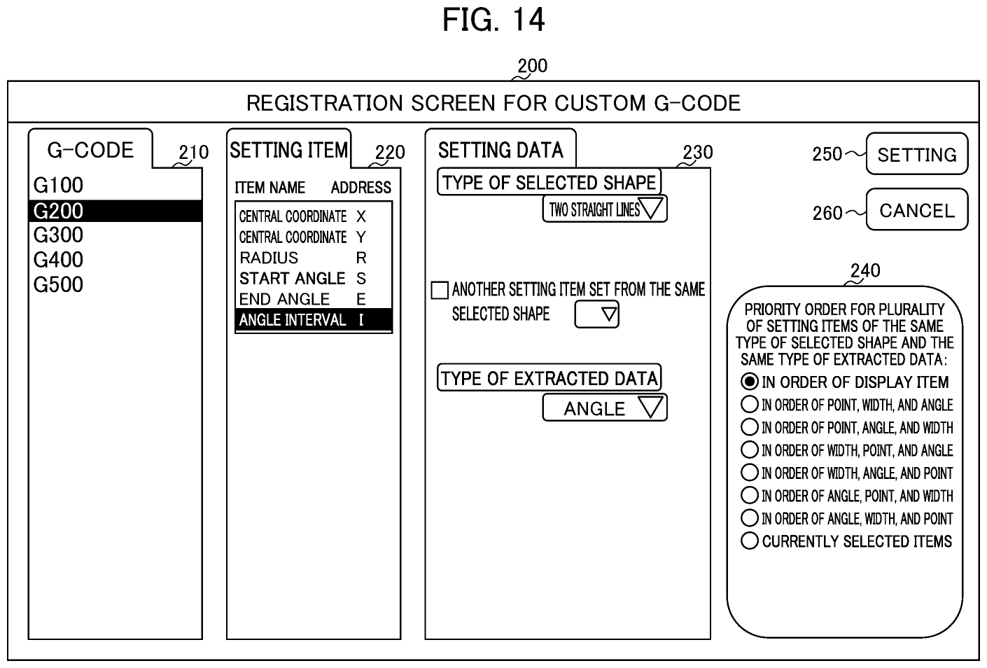

In the setting data 230, as illustrated in FIG. 12, the type of selected shape “two straight lines” and the type of extracted data “angle” are set by the user, for the setting item “start angle S” in the setting item 220. In the setting data 230, as illustrated in FIG. 13, the type of selected shape “two straight lines” and the type of extracted data “angle” are set by the user, for the setting item “end angle E” in the setting item 220. In the setting data 230, as illustrated in FIG. 14, the type of selected shape “two straight lines” and the type of extracted data “angle” are set by the user, for the setting item “angle interval I” in the setting item 220.

As mentioned above, the type of selected shape and the type of extracted data for the setting items “end angle E” and “angle interval I” are the same as the type of selected shape “two straight lines” and the type of extracted data “angle” for the setting item “start angle S”. Therefore, as illustrated in FIGS. 13 and 14, the G-code registration unit 110 may display the priority order 240 on the registration screen 200, which sets the priority order for setting the setting items “start angle S”, “end angle E”, and “angle interval I”. The G-code registration unit 110 may receive an input of the priority order such as the “item display order” in the priority order 240, based on an input operation of the input unit 12 by the user.

When the setting button 250 is pressed, the G-code registration unit 110 stores the association information of the set custom G-code “G200” as illustrated in FIG. 6 in the association information storage unit 142.

### <Setting Screen Control Unit 111>

The setting screen control unit 111, for example, displays the setting screen on the display unit 13, which automatically selects and sets the setting items of the custom G-code, based on an input operation of the input unit 12 by the user, to generate a machining program using the custom G-code.

The following describes the operation of displaying the setting screen of the setting screen control unit 111 for (a) the case of a custom G-code that calls a program for machining a gear, and (b) the case of a custom G-code that calls a program for machining a plurality of holes on the circumference.

(a) The Case of a Custom G-Code that Calls a Program for Machining a Gear

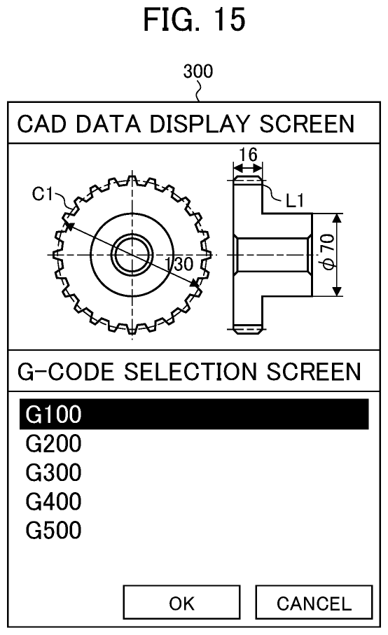

For example, when a command to generate a program for machining a gear based on the CAD data in FIG. 3 is received based on an input operation of the input unit 12 by the user, as illustrated in FIG. 15, the setting screen control unit 111 displays the setting screen 300, which includes a CAD data display screen for displaying the CAD data of the gear and a G-code selection screen for selecting the custom G-code, on the display unit 13.

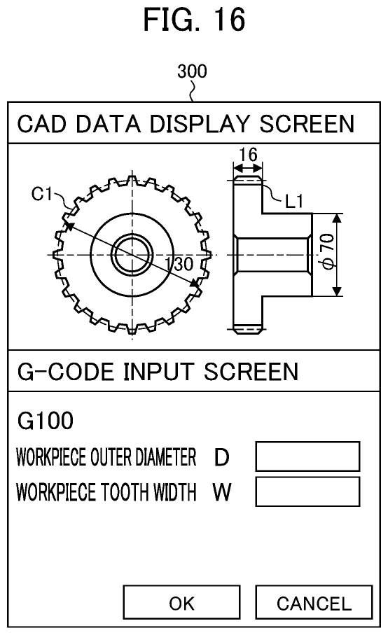

When the user specifies the custom G-code “G100” that calls a program for machining a gear via the G-code specifying unit 117 described later based on an input operation of the input unit 12 by the user, the setting screen control unit 111 displays the setting screen 300, which includes a CAD data display screen and a G-code input screen for setting the setting items “workpiece outer diameter D” and “workpiece tooth width W”, based on the association information of the custom G-code “G100” in FIG. 4, as illustrated in FIG. 16.

(b) The Case of a Custom G-Code that Calls a Program for Machining a Plurality of Holes on the Circumference

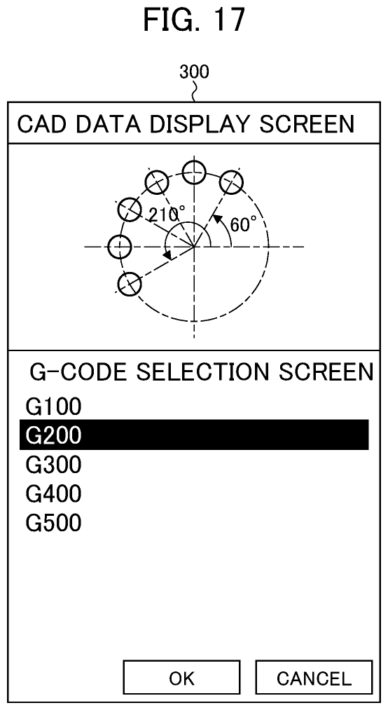

For example, when a command to generate a program for machining a plurality of holes on the circumference based on the CAD data of FIG. 5 is received based on an input operation of the input unit 12 by the user, the setting screen control unit 111 displays the setting screen 300, which includes a CAD data display screen for displaying the CAD data of the workpiece in which the holes H1 to H6 are generated on the circumference, and a G-code selection screen for selecting the custom G-code, on the display unit 13, as illustrated in FIG. 17. Note that the CAD data displayed on the CAD data display unit of the setting screen 300 is the same as FIG. 5, and is therefore described using the setting values and symbols of the CAD data in FIG. 5.

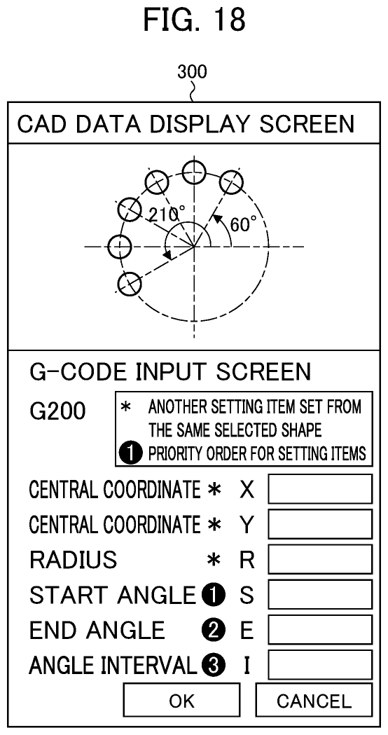

When the user specifies the custom G-code “G200” that calls a program for machining a plurality of holes on the circumference via the G-code specifying unit 117 described later based on an input operation of the input unit 12 by the user, the setting screen control unit 111 displays a setting screen 300, which includes a CAD data display screen and a G-code input screen for setting the setting items “central coordinate X”, “central coordinate Y”, “radius R”, “start angle S”, “end angle E”, and “angle interval I” as illustrated in FIG. 18, based on the association information of the custom G-code “G200” in FIG. 6.

Here, as indicated by the association information in FIG. 6, the setting items “central coordinate Y” and “radius R” are related to another setting item “central coordinate X” that is set from the same selected shape “circle”; therefore, the setting screen control unit 111 displays them with the same mark (such as “*”) and includes a text explaining the mark.

As a result, the user can know that these are the setting items set from the same selected shape.

As indicated by the association information in FIG. 6, the type of selected shape “two straight lines” and the type of extracted data “angle” are the same for the setting items “start angle S”, “end angle E”, and “angle interval I”. Therefore, based on the priority order (such as the item display order) in the association information in FIG. 6, the setting screen control unit 111 displays the setting items “start angle S”, “end angle E”, and “angle interval I” with marks “1”, “2”, “3” in the display order with a text explaining the marks, and displays them on the display unit 13.

As a result, the user can know the setting order of the setting items.

### <CAD Data Analysis Unit 112>

The CAD data analysis unit 112, for example, analyzes the CAD data that is stored in the shape information storage unit 141 and is displayed on the setting screen 300 in FIG. 16 or 18, and extracts the shapes (such as “circle” or “straight line”) that configure this CAD data. The CAD data analysis unit 112 stores the extracted shapes as the analysis elements in the analysis element storage unit 143.

### <Selected Shape Receiving Unit 113>

The selected shape receiving unit 113 receives the shape selected by the user using the analysis elements in the analysis element storage unit 143, as a selected shape, from among the shapes indicated by the CAD data displayed on the display unit 13.

Specifically, the selected shape receiving unit 113 receives the circle C1 indicating the outer diameter of the gear as a selected shape, from among the shapes of the CAD data on the setting screen 300 of FIG. 16, based on an input operation of the input unit 12 by the user. The selected shape receiving unit 113 may receive the straight line L1 indicating the tooth width of the gear as a selected shape from the user, from among the shapes of the CAD data on the setting screen 300 of FIG. 16.

On the other hand, the selected shape receiving unit 113 may receive the circle C2 as a selected shape, in which the holes H1 to H6 are generated on the circumference, from among the shapes of the CAD data on the setting screen 300 of FIG. 18, based on an input operation of the input unit 12 by the user. The selected shape receiving unit 113 may receive the two straight lines L20 and L21 forming the start angle, the two straight lines L20 and L26 forming the end angle, or the two straight lines L21 and L22 forming the angle interval, as a selected shape from the user, from among the shapes of the CAD data on the setting screen 300 of FIG. 18.

### <Data Type Acquisition Unit 114>

The data type acquisition unit 114 queries the association information storage unit 142 using the selected shape received by the selected shape receiving unit 113, and acquires the setting item and the type of extracted data for the selected shape.

Specifically, for instance, when the data type acquisition unit 114 receives the circle C1 indicating the outer diameter of the gear on the setting screen 300 of FIG. 16 as a selected shape from the selected shape receiving unit 113, the data type acquisition unit 114 acquires the setting item “workpiece outer diameter D” and the type of extracted data “diameter” for the received selected shape “circle”, based on the association information stored in the association information storage unit 142 illustrated in FIG. 4. When the data type acquisition unit 114 receives the straight line L1 indicating the gear width on the setting screen 300 of FIG. 16 as a selected shape from the selected shape receiving unit 113, the data type acquisition unit 114 may acquire the setting item “workpiece gear width W” and the type of extracted data “width” for the received selected shape “straight line”, based on the association information in FIG. 4.

On the other hand, for example, when the data type acquisition unit 114 receives the circle C2 in which the holes H1 to H6 are generated at equal intervals on the circumference on the setting screen 300 of FIG. 18 as the selected shape from the selected shape receiving unit 113, the data type acquisition unit 114 may acquire the setting items “central coordinates X”, “central coordinates Y”, and “radius R”, and the types of extracted data “center point” and “radius” for the received selected shape “circle”, based on the association information stored in the association information storage unit 142 illustrated in FIG. 6.

When the data type acquisition unit 114 receives the two straight lines L20 and L21 (or straight lines L20 and L26 or straight lines L21 and L22) on the setting screen 300 of FIG. 18 as the selected shape from the selected shape receiving unit 113, the data type acquisition unit 114 may acquire the setting items “start angle S”, “end angle E”, and “angle interval I”, and the type of extracted data “angle” for the received selected shape “two straight lines”, based on the association information in FIG. 6.

### <Setting Data Calculation Unit 115>

The setting data calculation unit 115 calculates the setting data, based on the setting items and the type of extracted data acquired by the data type acquisition unit 114, and the selected shape received by the selected shape receiving unit 113.

Specifically, for example, when the selected shape receiving unit 113 receives the circle C1 indicating the outer diameter of the gear on the setting screen 300 of FIG. 16 as the selected shape from the user, as mentioned above, the data type acquisition unit 114 acquires the setting item “workpiece outer diameter D” and the type of extracted data “diameter”. In this case, the setting data calculation unit 115 calculates the setting value of the diameter (such as “130 mm”) set in the circle C1 of the CAD data, as the setting data.

When the selected shape receiving unit 113 receives the straight line L1 indicating the gear width on the setting screen 300 of FIG. 16 as the selected shape from the user, the data type acquisition unit 114 acquires the setting item “workpiece gear width W” and the type of extracted data “width”. The setting data calculation unit 115 may calculate the setting value of the gear width (such as “16 mm”) set in the straight line L1 of the CAD data, as the setting data.

On the other hand, for example, when the selected shape receiving unit 113 receives the circle C2, in which the holes H1 to H6 are generated on the circumference, as the selected shape from the user on the setting screen 300 in FIG. 18, the data type acquisition unit 114 acquires the setting items “central coordinate X”, “central coordinate Y”, and “radius R”, and the types of extracted data “center point” and “radius”. In this case, as mentioned above, the setting item “central coordinate X” is registered in the association information of FIG. 6 as another setting item set from the same selected shape as the setting items “central coordinate Y” and “radius R”; therefore, the setting data calculation unit 115 may calculate the setting value set in the CAD data of the circle C2 (such as the central coordinates (0,0) and the radius “40 mm”) as the setting data.

When the selected shape receiving unit 113 receives two straight lines L20 and L21 as the selected shape from the user on the setting screen 300 in FIG. 18, the data type acquisition unit 114 acquires the setting items “start angle S”, “end angle E”, and “angle interval I”, and the type of extracted data “angle”. In this case, as mentioned above, the type of selected shape “two straight lines” and the type of extracted data “angle” are the same for the setting items “start angle S”, “end angle E”, and “angle interval I”; therefore, their priority order (such as the item display order) is registered in the association information of FIG. 6. Therefore, the setting data calculation unit 115 may calculate the setting value of the angle formed by the two straight lines L20 and L21 of the CAD data (such as “60°”) as the setting data for the setting item “start angle S” in the first setting order, based on the priority order in the association information of FIG. 6.

### <Item Data Setting Unit 116>

The item data setting unit 116 sets the setting data calculated by the setting data calculation unit 115 to the setting items acquired by the data type acquisition unit 114 from among the setting items on the setting screen 300.

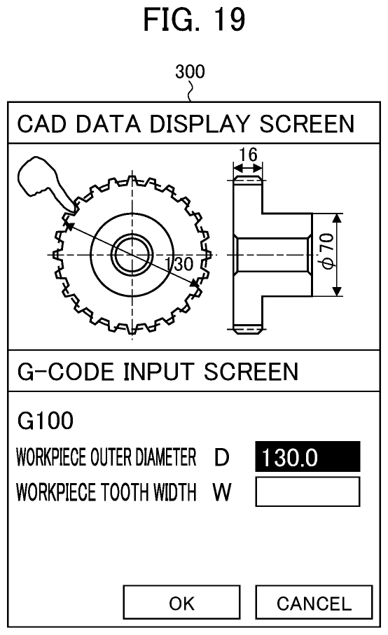

Specifically, when the selected shape receiving unit 113 receives the circle C1 as the selected shape from the user on the setting screen 300 in FIG. 16, for example, as illustrated in FIG. 19, the data type acquisition unit 114 acquires the setting item “workpiece outer diameter D” and the type of extracted data “diameter”, and the setting data calculation unit 115 calculates the setting value of the diameter set in the CAD data of the circle C1 (such as “130 mm”) as the setting data. The item data setting unit 116 sets the setting data calculated by the setting data calculation unit 115 to the setting item “workpiece outer diameter D” acquired by the data type acquisition unit 114, as illustrated in FIG. 19.

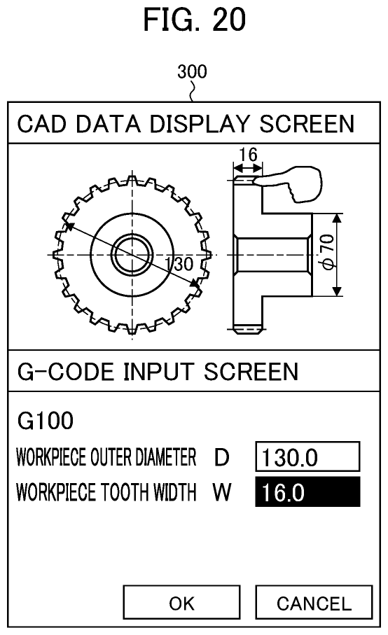

Next, when the selected shape receiving unit 113 receives the straight line L1 as the selected shape from the user on the setting screen 300 in FIG. 19, for example, as illustrated in FIG. 20, the data type acquisition unit 114 acquires the setting item “workpiece tooth width W” and the type of extracted data “width”, and the setting data calculation unit 115 calculates the setting value of the tooth width set in the CAD data of the straight line L1 (such as “16 mm”) as the setting data. The item data setting unit 116 sets the setting data calculated by the setting data calculation unit 115 to the setting item “workpiece tooth width W” acquired by the data type acquisition unit 114, as illustrated in FIG. 20.

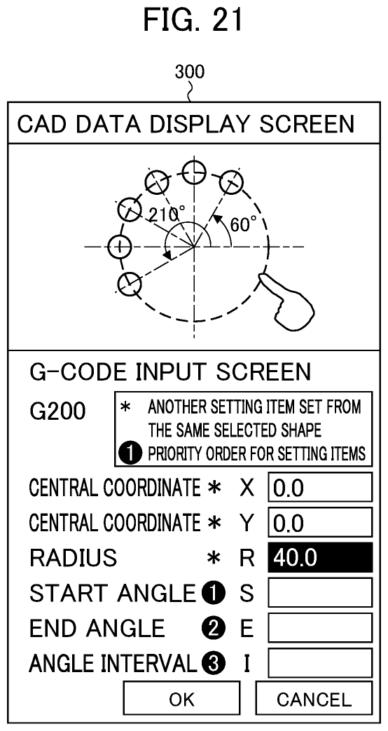

On the other hand, when the selected shape receiving unit 113 receives the circle C2 as the selected shape from the user on the setting screen 300 in FIG. 18, for example, as illustrated in FIG. 21, the data type acquisition unit 114 acquires the setting items “central coordinate X”, “central coordinate Y”, and “radius R”, and the types of extracted data “center point” and “radius”, and the setting data calculation unit 115 calculates the setting values set in the CAD data of the circle C2 (such as the central coordinates (0, 0) and the radius “40 mm”) as the setting data. As mentioned above, the setting items “central coordinate Y” and “radius R” are related to another setting item “central coordinate X” set from the same selected shape; therefore, the item data setting unit 116 collectively sets the setting data calculated by the setting data calculation unit 115 to the setting items “central coordinate X”, “central coordinate Y”, and “radius R” acquired by the data type acquisition unit 114, as illustrated in FIG. 20.

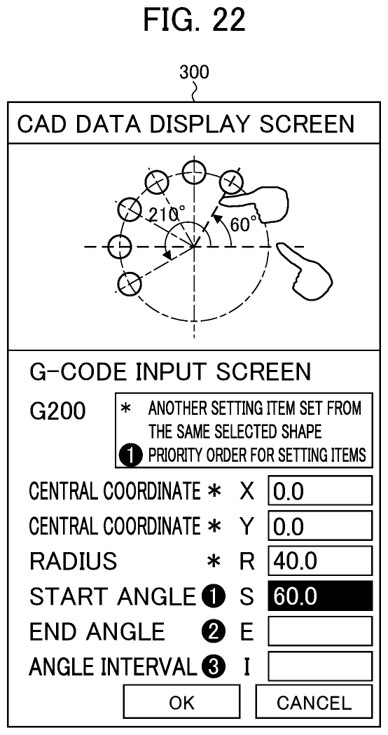

Next, as illustrated in FIG. 22, when the selected shape receiving unit 113 receives the two straight lines L20 and L21 as the selected shapes from the user on the setting screen 300 of FIG. 21, the data type acquisition unit 114 acquires the setting items “start angle S”, “end angle E”, and “angle interval I”, and the type of extracted data “angle”. As mentioned above, for instance, the setting data calculation unit 115 calculates the setting value of the angle formed by the two straight lines L20 and L21 of the CAD data (such as “60°”) as the setting data of the setting item “start angle S” of the first display order, based on the priority order of the linking information in FIG. 6. As illustrated in FIG. 22, the item data setting unit 116 sets the setting data calculated by the setting data calculation unit 115 to the setting item “start angle S” acquired by the data type acquisition unit 114.

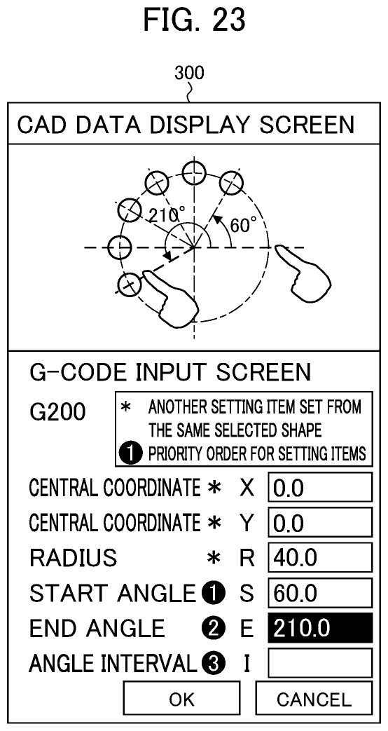

Next, as illustrated in FIG. 23, when the selected shape receiving unit 113 receives the two straight lines L20 and L26 as the selected shapes from the user on the setting screen 300 of FIG. 22, the data type acquisition unit 114 acquires the setting items “start angle S”, “end angle E”, and “angle interval I”, and the type of extracted data “angle”. The setting data calculation unit 115 calculates the setting value of the angle formed by the two straight lines L20 and L26 of the CAD data (such as “210°”) as the setting data of the setting item “end angle E” of the second display order, based on the priority order of the linking information in FIG. 6. As illustrated in FIG. 23, the item data setting unit 116 sets the setting data calculated by the setting data calculation unit 115 to the setting item “end angle E” acquired by the data type acquisition unit 114.

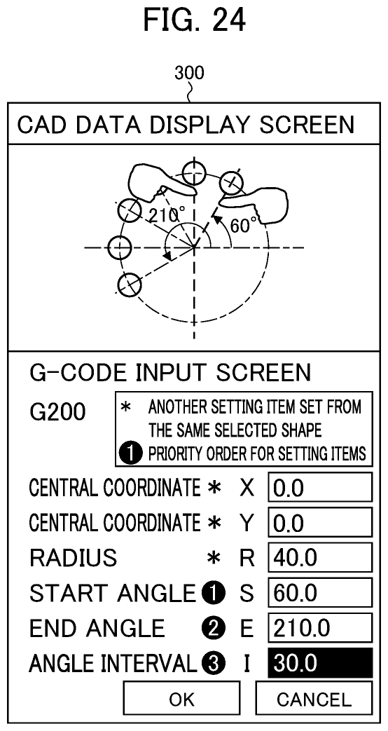

Finally, as illustrated in FIG. 24, when the selected shape receiving unit 113 receives the two straight lines L21 and L22 as the selected shapes from the user on the setting screen 300 of FIG. 23, the data type acquisition unit 114 acquires the setting items “start angle S”, “end angle E”, “angle interval I”, and the type of extracted data “angle”. The setting data calculation unit 115 calculates the setting value of the angle formed by the two straight lines L21 and L22 of the CAD data (such as “30°”) as the setting data of the setting item “angle interval I” of the third display order, based on the priority order of the linking information in FIG. 6. As illustrated in FIG. 24, the item data setting unit 116 sets the setting data calculated by the setting data calculation unit 115 to the setting item “angle interval I” acquired by the data type acquisition unit 114.

### <G-Code Specifying Unit 117>

As illustrated in FIG. 15 or FIG. 17, the G-code specifying unit 117, for example, specifies the custom G-code, based on an input operation of the input unit 12 by the user, on the setting screen 300 displayed on the display unit 13, which automatically selects and sets the setting items of the custom G-code.

### <G-Code Input Unit 118>

The G-code input unit 118, for example, inputs the custom G-code specified and the setting data of the setting items set on the setting screen 300 illustrated in FIG. 20 or FIG. 24 to the program generating unit 119 described later.

### <Program Generating Unit 119>

The program generating unit 119 generates a machining program using the custom G-code and the setting data of the setting items inputted by the G-code input unit 118.

### <Registration Processing of Numerical Control Device 10>

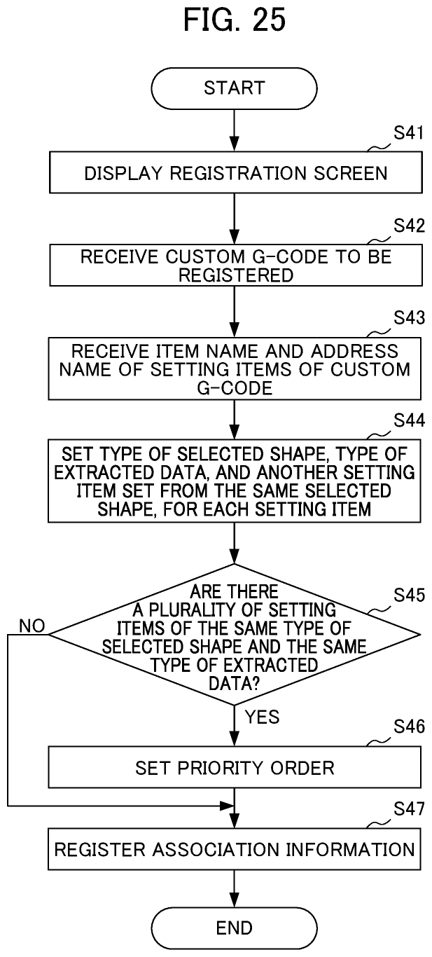

Next, referring to FIG. 25, the flow of the registration processing of the numerical control device 10 will be described.

FIG. 25 is a flowchart illustrating the registration processing of the numerical control device 10. The flow described herein is executed each time a command for registering a custom G-code is received from the user.

In Step S41, the G-code registration unit 110 receives a command to register a custom G-code, and displays the registration screen 200 on the display unit 13, based on an input operation of the input unit 12 by the user.

In Step S42, the G-code registration unit 110 receives the custom G-code to be registered to the G-code 210 on the registration screen 200, based on an input operation of the input unit 12 by the user.

In Step S43, the G-code registration unit 110 receives the item name and the address name (variable names of the custom G-code) of the setting items of the custom G-code inputted in Step S42, in the setting item 220 on the registration screen 200, based on an input operation of the input unit 12 by the user.

In Step S44, the G-code registration unit 110 sets the type of selected shape, the type of extracted data, and another setting item set from the same selected shape, for each setting item of the setting item 220, in the setting data 230 on the registration screen 200, based on an input operation of the input unit 12 by the user.

In Step S45, the G-code registration unit 110 determines whether there are a plurality of setting items of the same type of selected shape and the same type of extracted data. If there are a plurality of setting items of the same type of selected shape and the same type of extracted data, the processing proceeds to Step S46. On the other hand, if there are not a plurality of setting items of the same type of selected shape and the same type of extracted data, the processing proceeds to Step S47.

In Step S46, the G-code registration unit 110 sets the priority order for setting the plurality of setting items of the same type of selected shape and the same type of extracted data, in the priority order 240 on the registration screen 200, based on an input operation of the input unit 12 by the user.

In Step S47, the G-code registration unit 110 registers the association information of the custom G-code and stores the association information in the association information storage unit 142, when the setting button 250 is pressed based on an input operation of the input unit 12 by the user.

### <Program Generation Processing of Numerical Control Device 10>

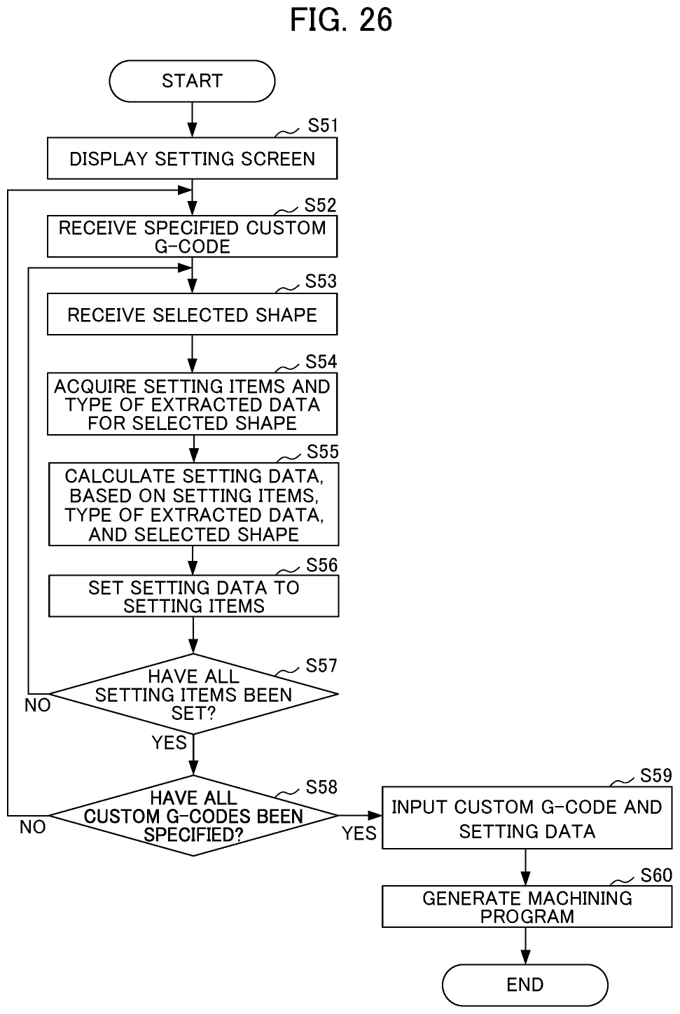

Next, referring to FIG. 26, the flow of the program generation processing of the numerical control device 10 will be described.

FIG. 26 is a flowchart illustrating the program generation processing of the numerical control device 10. The flow described herein is executed each time a command to generate a machining program is received from the user.

In Step S51, when receiving the command to generate a machining program, the setting screen control unit 111 displays the setting screen 300, which includes a CAD data display screen displaying CAD data and a G-code input screen, on the display unit 13, based on an input operation of the input unit 12 by the user.

In Step S52, the G-code specifying unit 117 specifies a custom G-code, based on an input operation of the input unit 12 by the user.

In Step S53, the selected shape receiving unit 113 receives a selected shape in the CAD data displayed in Step S51, based on an input operation of the input unit 12 by the user.

In Step S54, the data type acquisition unit 114 queries the association information storage unit 142 using the selected shape received in Step S53, and acquires the setting items and the type of extracted data for the selected shape.

In Step S55, the setting data calculation unit 115 calculates setting data, based on the selected shape received in Step S53, and the setting items and the type of extracted data acquired in Step S54.

In Step S56, the item data setting unit 116 sets the setting data calculated in Step S55 to the setting items acquired in Step S54, among the setting items on the setting screen 300.

In Step S57, the item data setting unit 116 determines whether all the setting items have been set. If all the setting items have been set, the processing proceeds to Step S58. On the other hand, if all the setting items have not been set, the processing returns to Step S53.

In Step S58, the G-code specifying unit 117 determines whether all the custom G-codes have been specified. If all the custom G-codes have been specified, the processing proceeds to Step S59. On the other hand, if all the custom G-codes have not been specified, the processing returns to Step S52.

In Step S59, the G-code input unit 118 inputs the specified custom G-code and the setting data of the set setting items, into the program generating unit 119.

In Step S60, the program generating unit 119 generates a machining program using the custom G-code and the setting data of the setting items thus inputted.

As described above, the numerical control device 10 according to one embodiment pre-registers the association information that associates the setting items for at least each custom G-code, the type of selected shape for each setting item, the type of extracted data, and another setting item set from the same selected shape. As a result, the numerical control device 10 can easily and quickly input each shape-related item of the custom G-code, allowing for saving the effort of inputting the custom G-code.

The numerical control device 10 can shorten the time to generate a machining program.

Although one embodiment has been described above, the numerical control device 10 is not limited to the above-described embodiment, and includes modifications and improvements within the range that can achieve the objective.

### Modification Example 1

In one embodiment, the numerical control device 10 registers association information for a custom G-code that calls a program for machining a gear, and a custom G-code that calls a program for machining a plurality of holes on the circumference; however, the present invention is not limited to this. For example, the numerical control device 10 may register association information for any custom G-code.

### Modification Example 2

For instance, in the embodiment described above, the setting screen control unit 111 displays the setting items “start angle S”, “end angle E”, and “angle interval I” so as to be set in this order with the display order marks “1”, “2”, and “3”, among the setting items of the custom G-code ‘G200’ that calls a program for machining a plurality of holes on the circumference; however, the present invention is not limited to this.

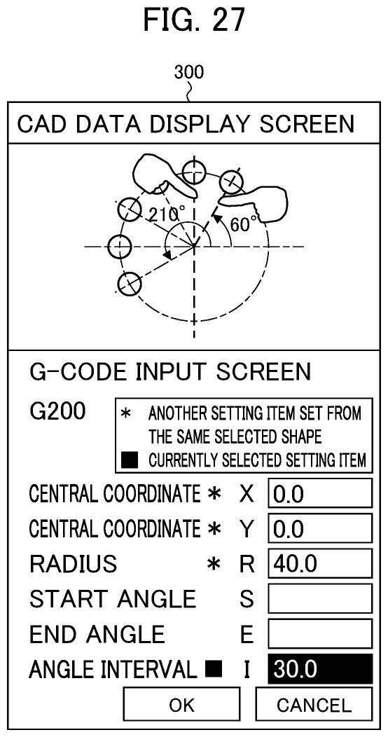

For instance, when the “currently selected item” is set as the priority order in the association information, the setting screen control unit 111 may display the currently selected setting item with a quadrangular mark including a text explaining the mark on the display unit 13, based on an input operation of the input unit 12 by the user, as illustrated in FIG. 27.

FIG. 27 is a diagram illustrating an example of the setting screen 300 when the priority order is the “currently selected item.”

As illustrated in FIG. 27, when the setting item “angle interval I” is selected by the user on the setting screen 300, and the selected shape receiving unit 113 receives the two straight lines L21 and L22 as the selected shapes from the user on the setting screen 300, the data type acquisition unit 114 acquires the setting items “start angle S”, “end angle E”, “angle interval I” and the type of extracted data “angle”. Since the setting item “angle interval I” is selected, the setting data calculation unit 115 calculates the setting value of the angle formed by the two straight lines L21 and L22 of the CAD data (such as “30°”) as the setting data for the selected setting item “angle interval I”. As illustrated in FIG. 27, the item data setting unit 116 sets the setting data calculated by the setting data calculation unit 115 to the selected setting item “angle interval I”.

Note that, as in the case of the setting item “angle interval I”, a quadrangular mark is also assigned to the setting items “start angle S” and “end angle E” when selected by the user, and the setting data is set.

### Modification Example 3

For example, in the above-described embodiment, among the setting items of the custom G-code “G200” that calls a program for machining a plurality of hole on the circumference, the setting item “central coordinate X” is registered in the association information of FIG. 6 as another setting item set from the same selected shape as the setting items “central coordinate Y” and “radius R”; therefore, as illustrated in FIG. 21, when the selected shape receiving unit 113 receives the circle C2, in which the holes H1 to H6 are generated, as the selected shape from the user, the item data setting unit 116 collectively sets the setting data for the setting items “central coordinate X”, “central coordinate Y”, and “radius R”; however, the present invention is not limited to this.

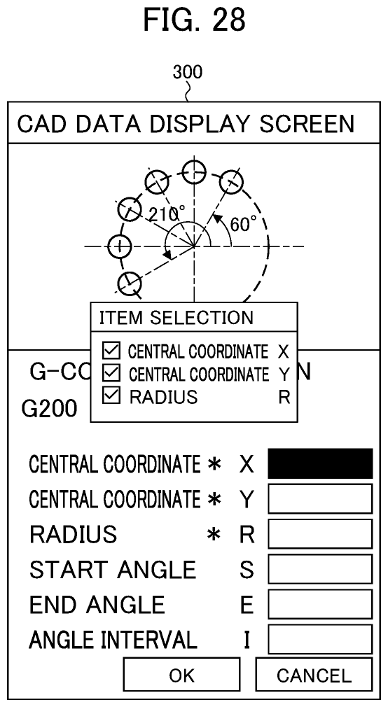

For instance, when “manually select a setting item” is registered as the priority order in the association information of FIG. 6, even if the setting item “central coordinate X” is registered in the association information as another setting item set from the same selected shape as the setting items “central coordinate Y” and “radius R”, the item data setting unit 116 may individually set the setting items “central coordinate X”, “central coordinate Y”, and “radius R”, based on an input operations of the input unit 12 by the user. In this case, as illustrated in FIG. 28, the setting screen control unit 111 may pop up a screen to allow the user to select a setting item from among the setting items “central coordinate X”, “central coordinate Y”, and “radius R” to set.

As a result, the user can set the setting data to any setting item from the item list.

Alternatively, when “manually select a setting item” is registered as the priority order in the association information of FIG. 6, the setting screen control unit 111 may pop up a screen to allow the user to select a setting item for the received selected shape, each time the selected shape receiving unit 113 receives a selected shape from the user.

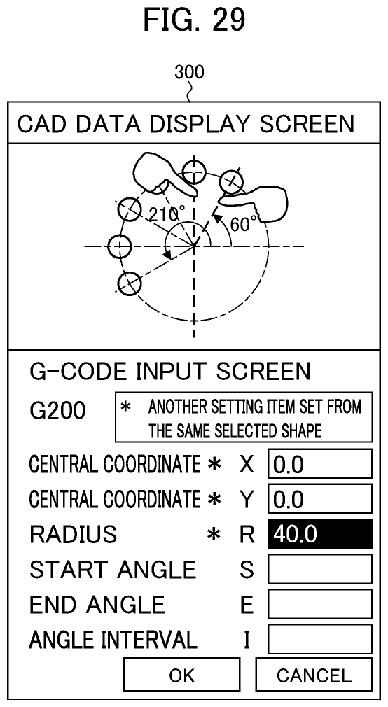

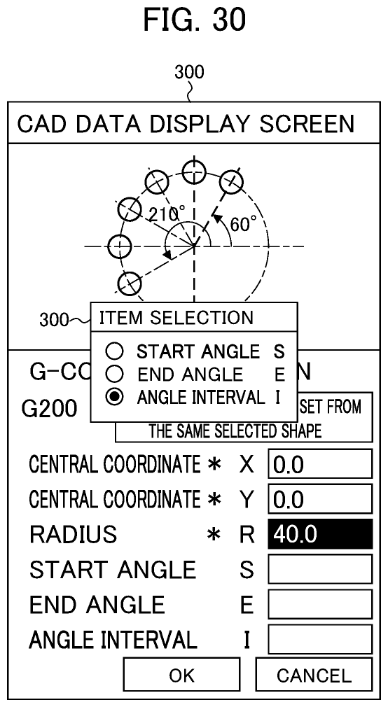

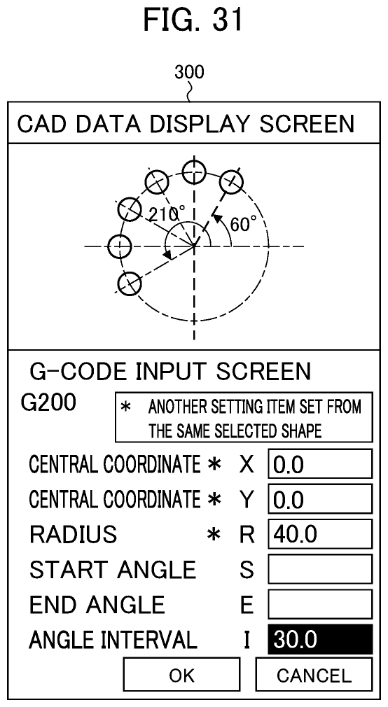

As illustrated in FIG. 29, when the selected shape receiving unit 113 receives the two straight lines L21 and L22 from the user on the setting screen 300, the data type acquisition unit 114 acquires the setting items “start angle S”, “end angle E”, and “angle interval I”, and the type of extracted data “angle”, for the two straight lines L21 and L22 of the received selected shape, based on the association information in FIG. 6. As illustrated in FIG. 30, the setting screen control unit 111 may pop up the item selection screen 310 that displays a list of the setting items “start angle S”, “end angle E”, and “angle interval I”. When the setting item “angle interval I” is selected by the user on the item selection screen 310, the setting data calculation unit 115 may calculate the setting value of the angle formed by the two straight lines L21 and L22 in the CAD data (such as “30°”) as the setting data for the setting item “angle interval I”. As illustrated in FIG. 31, the item data setting unit 116 may set the setting data calculated by the setting data calculation unit 115 to the setting item “angle interval I”.

Thus, by displaying a single selection list on the item selection screen 310, the user can prevent selection errors.

In the case where all or part of the numerical control device 10 is configured by software, the software can be implemented by storing information necessary for computation in a DRAM, and running programs that describe all or part of the operation of the numerical control device 10 by a CPU, on a computer configured with a storage unit such as a hard disk drive or ROM that stores the program, the DRAM that stores data necessary for computation, the CPU, and a bus connecting the units.

These programs can be stored using various types of non-transitory computer-readable media and can be provided to a computer. Non-transitory computer-readable media include various types of tangible storage media. Examples of non-transitory computer-readable media include magnetic recording media (such as flexible disks, magnetic tape, hard disk drives), magneto-optical recording media (such as magneto-optical disks), CD-ROMs (Read Only Memory), CD-Rs, CD-R/Ws, and semiconductor memory (such as mask ROM, PROM (Programmable ROM), EPROM (Erasable PROM), flash ROM, and RAM). The programs may be supplied to a computer by various types of transitory computer-readable media. Examples of transitory computer-readable media include electrical signals, optical signals, and electromagnetic waves. Transitory computer-readable media can supply programs to a computer via wired communication paths such as electric wires and optical fibers, or via wireless communication paths.

These programs may be distributed by downloading to the user's computer via a network.

Note that the steps describing the program recorded on the recording medium include not only processing executed in chronological order, but also processing executed in parallel or individually, not necessarily in chronological order.

In other words, the numerical control device of the present disclosure can take various embodiments having the following configuration.

(1) The numerical control device 10 of the present disclosure includes: a custom G-code registration unit 110 configured to register association information that associates a uniquely customized custom G-code, at least one item set in the custom G-code, a type of shape set for each item, and a type of extraction data extracted from the shape; an association information storage unit 142 configured to store the association information registered; a selected shape receiving unit 113 configured to receive the shape selected by the user from among the shapes indicated by CAD data displayed on the display unit 13; a data type acquisition unit 114 configured to query the association information storage unit by using the selected shape and acquire the type of item and extracted data for the selected shape; a setting data calculation unit 115 configured to calculate setting data, based on the acquired type of item and extracted data and the selected shape; and an item data setting unit 116 configured to set the setting data calculated by the setting data calculation unit 115 to the acquired item.

According to this numerical control device 10, each shape-related item of the custom G-code can be inputted easily and quickly.

(2) In the numerical control device 10 described in (1), when there are a plurality of items of the same type of shape and the same type of extracted data, the G-code registration unit 110 may set a priority order for the plurality of items and register the priority order in the association information.

As a result, the numerical control device 10 can inform the user in which order to set which setting item for the plurality of items of the same type of shape and the same type of extracted data.

(3) In the numerical control device 10 described in (1) or (2), when there are a plurality of items set from the same selected shape, the G-code registration unit 110 may register the plurality of items set from the same selected shape in the association information such that the plurality of items set from the same shape selected can be collectively set to a plurality of related items can be collectively set.

As a result, the numerical control device 10 can save the effort of inputting a custom G-code.

(4) In the numerical control device 10 described in (2), when there is one item for the selected shape, the item data setting unit 116 may automatically select the item for the selected shape and set the calculated setting data to the item selected; and when there are a plurality of items of the same type of shape and the same type of extracted data, the item data setting unit 116 may automatically select each item and set the calculated setting data to each item selected, based on the set priority order.

As a result, the numerical control device 10 can shorten the time to generate a machining program.

(5) In the numerical control device 10 described in (3), when there are a plurality of items set from the same selected shape, the item data setting unit 116 may collectively set the calculated setting data to each of the plurality of related items.

As a result, the numerical control device 10 can save the effort of inputting the custom G-code more efficiently.

(6) The numerical control device 10 described in (2) or (4) may further include the setting screen control unit 111 configured to display items and priority orders, based on the association information registered by the G-code registration unit 110.

As a result, the numerical control device 10 can achieve the same effects as in (2) and (4).

(7) In the numerical control device 10 described in (6), the setting screen control unit 111 may list a plurality of items of the same type of shape and the same type of extracted data, and the item data setting unit 116 may set the calculated setting data to the selected item, from among the plurality of items listed.

As a result, the numerical control device 10 can achieve the same effects as in (6).

### EXPLANATION OF REFERENCE NUMERALS

10: numerical control device
11: control unit
110: G-code registration unit
111: setting screen control unit
112: CAD data analysis unit
113: selected shape receiving unit
114: data type acquisition unit
115: setting data calculation unit
116: item data setting unit
117: G-code specifying unit
118: G-code input unit
119: program generating unit
12: input unit
13: display unit
14: storage unit
141: shape information storage unit
142: association information storage unit
143: analysis element storage unit

1. A numerical control device, comprising:
a G-code registration unit configured to register association information that associates a uniquely customized custom G-code, at least one item set in the custom G-code, a type of shape set for each item, and a type of extracted data extracted from the shape;
an association information storage unit configured to store the association information registered;
a selected shape receiving unit configured to receive a shape selected by a user from among shapes indicated by CAD data displayed on a CAD data display unit;
a data type acquisition unit configured to query the association information storage unit by using the shape selected, and acquire an item and a type of extracted data corresponding to the shape selected;
a setting data calculation unit configured to calculate setting data, based on the item and the type of extracted data acquired, and the shape selected; and
an item data setting unit configured to set the setting data calculated by the setting data calculation unit to the item acquired.

2. The numerical control device according to claim 1, wherein
when there are a plurality of items of the same type of shape and the same type of extracted data, the G-code registration unit sets a priority order for the plurality of items, and registers the priority order in the association information.

3. The numerical control device according to claim 1, wherein
when there are a plurality of items set from the same shape selected, the G-code registration unit registers the plurality of items set from the same shape selected in the association information such that the plurality of items set from the same shape selected can be collectively set to a plurality of related items.

4. The numerical control device according to claim 2, wherein
when there is one item for the shape selected, the item data setting unit automatically selects the item, and sets the setting data calculated to the item selected, and
when there are a plurality of items of the same type of shape and the same type of extracted data, the item data setting unit automatically selects each item, based on the priority order set, and sets the setting data calculated to each item selected.

5. The numerical control device according to claim 3, wherein
when there are a plurality of items set from the same shape selected, the item data setting unit collectively sets the setting data calculated to each of the plurality of related items.

6. The numerical control device according to claim 2, further comprising a setting order display unit configured to display the item and the priority order, based on the association information registered by the G-code registration unit.

7. The numerical control device according to claim 6, wherein
when there are a plurality of items of the same type of shape and the same type of extracted data, the setting order display unit lists the plurality of items applicable, and
the item data setting unit sets the setting data calculated to an item selected from the plurality of items listed.
